(19) United States
(12) Patent Application Publication
(10) Pub. No.: US 2007/0172599 A1
(43) Pub. Date: Jul. 26, 2007

(54) Method of resin infusion and parts formed thereby

(76) Inventors: Payton R. Lewis, Lake Wylie, SC (US); Richard F. Zopf, Salisbury, NC (US)

Correspondence Address: SAND & SEBOLT, AEGIS TOWER, SUITE 1100, 4940 MUNSON STREET, NW, CANTON, OH, 44718-3615, US

(21) Appl. No.: 11/656,127

(22) Filed: Jan. 22, 2007

Related U.S. Application Data
(60) Provisional application No. 60/761,864, filed on Jan. 25, 2006.

(51) Int. Cl. B05D 3/00; B05D 3/02; B05D 1/18

(52) U.S. Cl. 427/430.1; 427/384; 427/294

(57) ABSTRACT

A resin, method of resin infusion, and parts formed thereby are disclosed. The method is particularly useful in greatly strengthening appearance prototypes such as those formed on powder bed three-dimensional printers to make them suitable for handling and testing in a host of environments. The method comprises heating the liquid resin to lower its viscosity, infusing a porous form with the heated resin and curing the infused resin to form the part. The liquid resin is typically heated from about 35° C. to about 80° C. and most preferably is under vacuum with the porous form submerged therein to facilitate infusion. Excess resin is removed from the porous form and reusable for subsequent infusion. The resin-infused form is then cured, typically by heating in the range of 100° C. to 200° C. Resulting parts may be very hard and have very high compressive strengths, even exceeding 30,000 psi.

### CROSS REFERENCE TO RELATED APPLICATIONS

This application is a standard utility of U.S. Provisional Patent Application Ser. No. 60/761,864 filed Jan. 25, 2006; the disclosure of which is incorporated herein by reference.

### BACKGROUND OF THE INVENTION

1. Technical Field

The invention relates generally to a method of infusing porous forms with a liquid resin which is cured to form a part which is substantially stronger than the original porous form. More particularly, the invention relates to such a method utilizing a vacuum to assist in infusing the resin into the porous form. Specifically, the invention relates to such a method involving the heating of a catalyzed resin to lower its viscosity to facilitate the infusion.

2. Background Information

The popularity of three dimensional or 3D prototyping from CAD drawings represents a rapidly growing market. The rapid creation of a part was first accomplished with UV lasers curing liquid resins to create 3D parts but the materials are expensive and it can take up to two days to produce a part of any size. Powder bed prototyping is an advancement in the art that uses a specially treated powder and a standard industrial printing head (such as those sold by Hewlett Packard) to apply a developing/curing solution or binder to the dry powder where the part is to become hard. More particularly, a thin layer of powder is laid down and the printing head deposits the hinder on the layer of powder along a cross section of the 3D CAD drawing. Subsequent layers of powder and binder are likewise deposited and the process repeated as many times as is necessary to create the part. This process has the advantage of creating parts faster (hours vs. days) and at a lower cost per cubic inch of part (a few dollars vs. hundreds of dollars). Such a machine—or powder printer—is available from Z Corporation of Burlington, Mass. (hereinafter “Z Corp”).

These 3D printers produce porous appearance prototypes, units that look like the finished part, but are not made of materials that can be used to test or use the part directly. Appearance prototypes are the exact shape, potentially the same size and color of the 3D parts which look like the final part but do not have the physical properties to be functionally evaluated. These appearance prototypes give manufacturers the ability to look at a part for fitness and form.

Due to the relative low strength of these appearance prototypes, there is thus a need for a means of increasing their strength for handling and testing to make them viable for many applications in the market. The infusion of resin into porous forms is generally known in the art. However, the known methods of infusion typically either involve infusion wherein the resin achieves a minimal penetration of the porous form and thus fails to achieve the part strength needed for many applications or the method involves the use of costly apparatus. In addition, excess resin is typically not usable for subsequent infusion. The unused resin is waste and can be as much as 60% of the resin consumed in the infusion process. This waste adds substantially to the net cost of resin infusion.

Several different types of coatings have been used to increase the handling strength of the appearance prototypes produced by the Z Corp machines. The first involves coating the prototype surface by dripping a low viscosity cyanoacrylate resin onto the prototype. The second involves painting the prototype with a two-part epoxy or polyester that has a shelf-life of about 30 minutes to one hour and allowing it to soak into the form before it gels. The latter will cure fully in one to seven days or can be accelerated with an elevated temperature in an oven. Unused material cures and is discarded.

The drawbacks of using these coating materials, beside some difficulty in handling them, are limited penetration into the prototype part and limited reinforcement of the total composition. Cyanoacrylate only penetrates about 0.015 inch and the two-part systems—epoxies and polyesters—only penetrate 0.050-0.070 inch of the outside shell. The rest of the form remains low strength, typically the consistency of a low strength plaster.

Prior art also includes one method in which the resin penetration into the porous form is substantially 100% for relatively thin parts (typically 0.050 to 0.100 inches thick) where the porous form has pore sizes similar to those formed on a powder bed 3D printer, but this method requires high pressurization. More particularly, an unheated resin is disposed in a chamber which is open to the atmosphere and the porous form is in a distinct vacuum chamber wherein the two chambers are connected to one another by a tube extending therebetween. A vacuum is applied to the form and the air drawn from the part. Resin is then allowed to flow from the resin chamber through the tube to the chamber with the porous form. The resin is allowed to flow over the part and then brought to ambient pressures. The chamber is then pressurized to a high pressure and the resin driven into the form. The part is removed, excess resin drained and the part cured. The excess resin is thrown away. High viscosity of the resin limits penetration. In addition, penetration of this prior art resin into such a porous form at atmospheric pressure is extremely limited, and virtually non-existent for practical purposes.

Thus, a need exists for a high strength reinforcing composition and a means of fully incorporating it into the powder matrix to fully reinforce and improve the strength of the appearance prototype. The present invention addresses these needs and other problems in the art.

### BRIEF SUMMARY OF THE INVENTION

The present invention provides a method comprising the steps of heating liquid resin to a temperature of at least 35° C. to lower its viscosity; infusing a porous form with the heated resin; and curing the infused resin.

The present invention further provides a resin well suited to this method and the parts formed thereby.

### BRIEF DESCRIPTION OF THE SEVERAL VIEWS OF THE DRAWINGS

FIG. 1 is a diagrammatic view of the infusion apparatus of the present invention showing a porous form prior to placement in the resin chamber.

FIG. 2 is a sectional view taken on line 2-2 of FIG. 1 showing the porous form with air-filled interstitial spaces.

FIG. 3 is a view similar to FIG. 1 showing an early stage of the first method of the present invention with the porous form submerged in the resin bath with the resin chamber being heated and under vacuum.

FIG. 4 is similar to FIG. 2 and shows the interstitial spaces of the porous form filled with liquid resin.

FIG. 5 is similar to FIG. 3 and shows the porous form having been removed from the resin bath and placed on a draining rack to drain excess resin therefrom.

FIG. 6 is a diagrammatic view showing the draining rack and the forced air oven with the porous form having been moved into the oven.

FIG. 7 is similar to FIG. 5 and shows the interstitial spaces of the porous form filled with cured solid resin.

FIG. 8 is a flow chart showing the basic steps of the first method of infusion.

FIG. 9 is a view similar to FIG. 3 showing an early stage of the second method of the present invention with the porous form above the resin bath within the resin chamber, which is being heated and is under vacuum to draw gasses out of the porous form and resin bath.

FIG. 10 is a view similar to FIG. 9 and shows the porous form being submerged in the resin bath.

FIG. 11 is similar to FIG. 10 and shows the breaking of the vacuum and the resin infusing into the porous form.

FIG. 12 is a flow chart showing the basic steps of the second method of infusion.

Similar numbers refer to similar parts throughout the drawings.

### DETAILED DESCRIPTION OF THE INVENTION

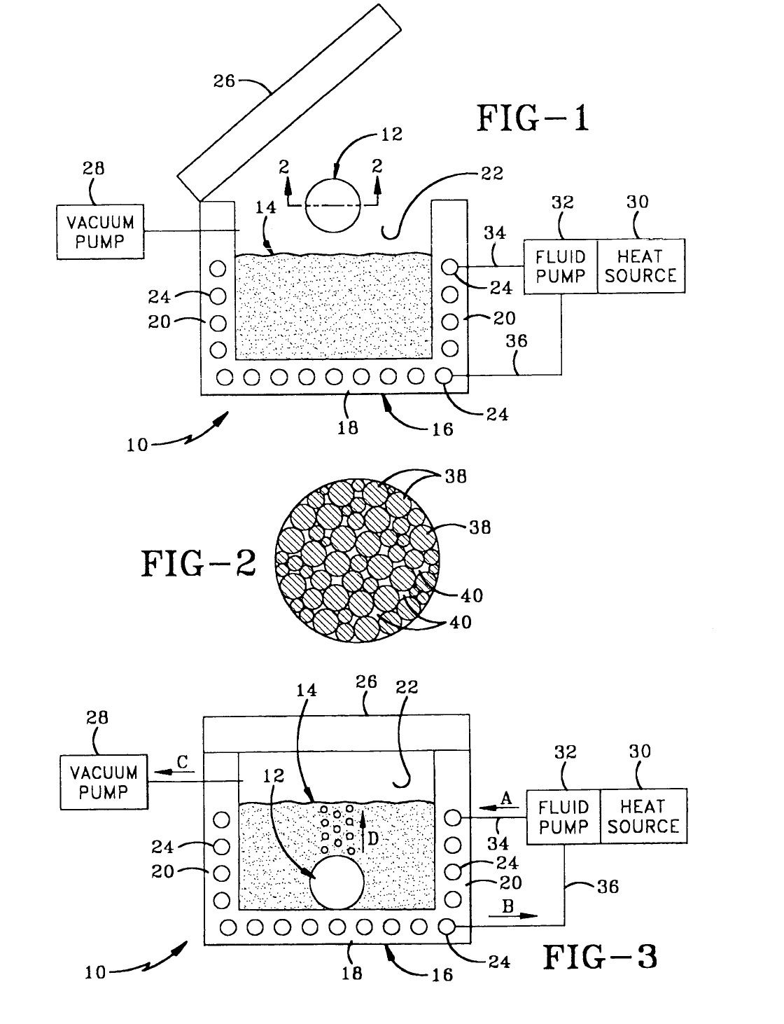

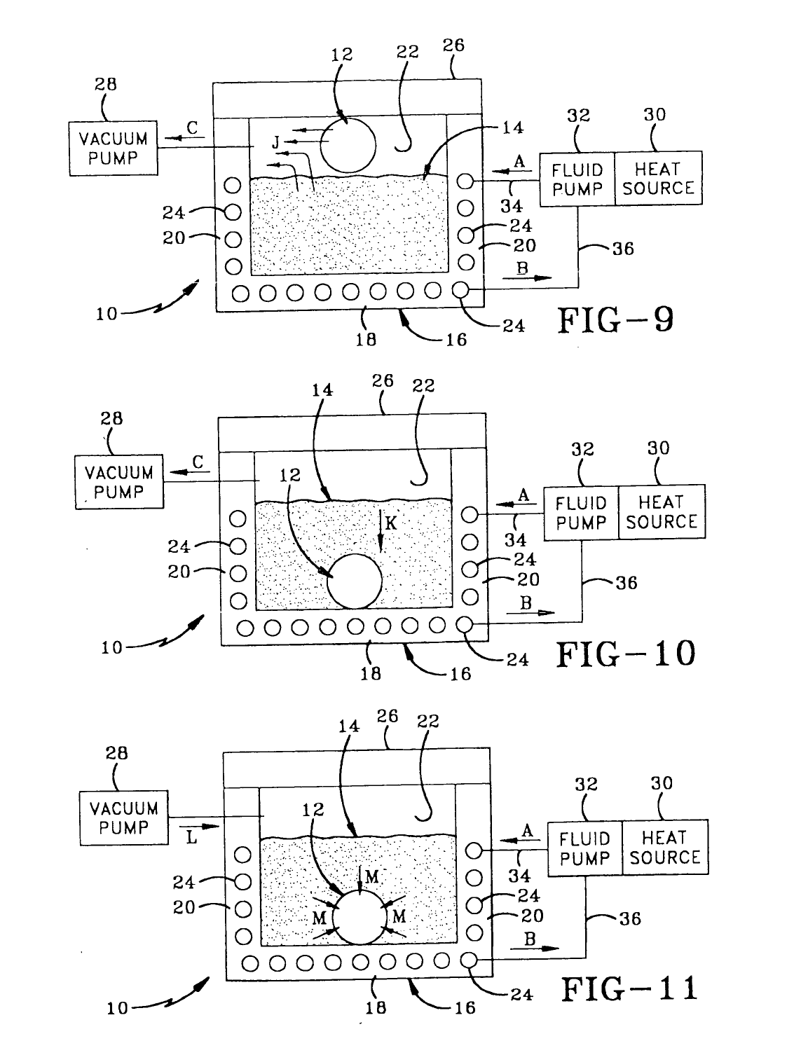

The infusion apparatus of the present invention is indicated generally at 10 in FIG. 1. Apparatus 10 is configured to infuse a porous form 12 with a proprietary liquid resin 14 to produce a resin infused form which is cured in a curing apparatus to be described further below. A first method of infusion is shown in FIGS. 1-8 and a second method is shown in FIGS. 9-12. In short, resin 14 is a fully catalyzed and substantially non-volatile resin which may be heated without curing to a suitable temperature to lower its viscosity so that it is highly suited to infusion into form 12 while maintaining a surprising degree of stability in liquid form at the associated elevated infusion temperatures and while under vacuum.

Porous form 12 may be formed of any suitable substance having pores or interstitial spaces which allow for the infusion of liquid resin 14 therein. For simplicity, porous form 12 is shown here as a sphere although any imaginable shape may be used with the present method. Essentially any porous form that may be feasibly handled during the present process may be used. Porous forms having specifically modeled shapes may be formed, for example, via 3D printers, such as those available from Z Corp. of Burlington, Mass. The Z Corp. 3D printer essentially works by alternately spreading respective layers of powder and spraying a liquid binder with an ink jet print head onto the powder at the cross section of a computer developed model of the desired final form. Typically, the powder used in this process is or is similar to a gypsum, plaster of paris or the like. Metal powders and other particulates can also be used in certain cases. The binder used with the Z Corp. printer is water-based and comprises ethlyene vinyl alcohol with partial acetate conversion for alcohol solubility, and surfactants and other minor components besides water.

The powder/binder combination used to produce a porous form on the Z Corp printing machine is not fully cross-linked when removed from the printer's powder bed, nor does it fully cross link with time. It has been found that heating or pre-baking porous forms produced in this manner in an oven at temperatures of 100° C. to 200° C. before resin infusion helps greatly to reduce warpage and cracking when curing. More particularly, if this particular powder/binder combination is not heated sufficiently prior to infusion, when the cure temperature of resin 14 reaches about 135° C., the binder breaks down to produce acetic acid which will pressurize within the resin-infused form 12 and may cause the part to explode. Even if the cure temperature of resin 14 does not reach about 135° C., the final part may otherwise be heated to this temperature and likewise result in such part explosion or other part damage. Thus, when this binder is used, it is preferred to heat or pre-bake the porous form at a temperature of at least 135° C. to eliminate this risk. Typically, such parts are cured at a temperature of at least 140° C. for additional security. In one test, a porous form with a ¾ inch thick section was pre-baked at 140° C. for five hours to eliminate subsequent problems. Heating times will vary depending on various factors such as part density and thickness.

Apparatus 10 includes a resin chamber 16 in the form of a water-jacketed vacuum chamber, which is shown in an open position in FIG. 1. Chamber 16 includes a bottom wall 18 and a side wall 20 extending upwardly therefrom to define a cavity 22 therewithin for containing liquid resin 14. In the exemplary embodiment, walls 18 and 20 include one or more fluid-carrying conduits 24 for allowing the flow of heated water or another liquid therethrough. Chamber 16 includes a lid 26 or other access door which is movable between an open position (FIG. 1) and a closed position (FIG. 3) in which chamber 16 is sealed to allow a vacuum to be placed on the contents of cavity 22 via a vacuum pump 28 which is in communication with cavity 22. Apparatus 10 further includes a heat source 30 for heating fluid which is pumped by a fluid pump 32 through conduit 24 via a feed line 34 and a return line 36 which are respectively in fluid communication with conduit 24 and pump 32. The use of a heated fluid is a simple and cost effective means of heating resin 14 although it will be appreciated that any heat source and suitable apparatus may be used for this purpose. In addition, a container for holding liquid resin 14 may be placed inside of a vacuum chamber for the purposes of the present process. However, it is generally more advantageous to have resin 14 in direct contact with heated walls of the vacuum chamber, such as walls 18 and 24 because it simplifies the heating of a material within a vacuum environment.

FIG. 2 shows a diagrammatic sectional view of porous form 12 which is enlarged to show particles of solid material 38, which may be in the form of a powder and binder as previously noted, and gas-filled pores or interstitial spaces 40 disposed between material 38. More particularly, spaces 40 are typically filled with air and some degree of moisture in liquid or vapor form. The size of pores 40 and the particles making up material 38 may vary quite a bit. When the particles are sufficiently small, capillary flow occurs and capillary action retains resin 14 within the spaces 40 of form 12. Obviously, this varies depending on the specific viscosity of resin 14 and other factors. For use in the powder bed prototyping discussed in the Background section above, the particles are sufficiently small to deposit a layer of the particles having a thickness on the order of 0.003 inch.

While the present method may be used with pores 40 which are relatively large, it is highly suited to pore sizes smaller than known prior art methods. For instance, the method is effective for an average pore size of 90 microns or less. Even more notably, the average pore size may be 80 microns, 70 microns, 60 microns, 50 microns, 40 microns, 30 microns, 20 microns, 10 microns, 5 microns or less. The size of particles likewise may be in such smaller ranges, for instance, from about 150 microns down to 5 microns or less. The largest particle size of the powder used in the Z Corp powder bed printer is typically no greater than 20 microns, with the majority being 5 microns or less, with an average size of about 5 to 7 microns. The average pore size of said powder is typically less than 20 microns.

With reference to FIG. 3, the method of infusion is described. As shown in FIG. 3, porous form 12 is submerged in the bath of liquid resin 14 and lid 26 is closed to form a sealed resin chamber 16. Heat source 30 and pump 32 will typically have been operated prior to the submersion of form 12 in order to heat liquid resin 14 to a desired temperature in order to lower its viscosity to facilitate the infusion thereof into form 12. One embodiment of resin 14 has a viscosity which at 15° C. is about 28,000 cPs; at 20° C. is about 13,860 cPs; at 25° C. is about 6,250 cPs; at 30° C. is about 3,660 cPs; at 35° C. is about 2,175 cPs; at 40° C. is about 1,383 cPs; at 45° C. is about 859 cPs; at 50° C. is about 602 cPs; at 60° C. is about 290 cPs; and at 70° C. is about 158 cPs. When infusing a porous form having the fine particles and interstitial spaces typical of that formed on the Z Corp 3D printer, it has been found that for this embodiment of resin 14, temperatures of 55° C., or higher provide relatively rapid infusion rates. Especially for use with such porous forms, resin viscosity of about 500 cPs or below is preferred, about 450 cPs or below more preferred and about 400 cPs or below even more preferred. It is noted, however, that depending on the pore size of the interstitial spaces of the porous form, higher viscosities may provide reasonably rapid infusion.

Arrows A and B in FIG. 3 represent the flow of water or other liquid via feed lines 34 and 36 through conduit 24 in order to heat walls 18 and 20 and resin 14. After chamber 16 has been sealed, vacuum pump 28 is operated to remove gasses and the like from cavity 22 (Arrow C) to reduce the pressure within cavity 22. While the degree of vacuum may vary, it has been found that a vacuum level within cavity 22 of about 28 to 29 inches of water works well. Resin 14 is non-volatile and thus well-suited to being submitted to a reduced pressure atmosphere without loss of resin 14 as a result. The vacuum placed on liquid resin 14 and porous form 12 causes any gasses and liquids within the interstitial spaces 40 of form 12 to exit spaces 40 as liquid resin 14 fills spaces 40. Said gasses and moisture then bubble to the upper surface of liquid resin 14 as indicated at Arrow D in FIG. 3 and are consequently evacuated via vacuum pump 28 from cavity 22.

During the infusion process, liquid resin 14 is typically heated to and maintained at a temperature ranging from 35-85° C. (95-185° F.). More preferably, resin 14 is maintained at a temperature ranging from 40-70° C. (104-158° F.) and even more preferably at a temperature ranging from 40-60° C. (104-140° F.). The viscosity of resin 14 is substantially reduced when heated to these temperature ranges. While the viscosity of resin 14 generally decreases with increased temperature, which generally facilitates infusion into form 12, nonetheless at a certain point, the higher temperatures begin to undesirably limit the life of resin 14 in a liquid form because resin 14 is a one-part thermoset resin. On the other hand, if resin 14 is not heated above, say room temperature (about 22° C./72° F.), infusion will still take place but at a substantially slower pace than at the given elevated temperature ranges. Unlike the prior art resins known, liquid resin 14 can be maintained virtually indefinitely at room temperature, has been maintained at 60° C. for 5 days (120 hours) while under continuous vacuum of 28 to 29 inches of water and at 80° C. for up to 1 hour while still being effective for purposes of infusion. At atmospheric pressure, resin 14 may be maintained at 60° C. for three to six weeks while remaining suitable for infusion purposes.

Due to the substantial reduction of the viscosity of resin 14 at the elevated temperature ranges, infusion of resin 14 into form 12 even without a vacuum placed thereon will often provide sufficient penetration within a reasonable time to be of value in many instances. By way of example, powder bed prototypes produced on a Z Corp 3D printer were submerged in one embodiment of resin 14 heated to and maintained at 60° C. and atmospheric pressure throughout an infusion or penetration rate test. The test showed an infusion or penetration rate of the resin into the prototype of 0.253 inch in the first 0.5 hour for an average rate of about 0.506 inch per hour or 0.0084 inch per minute; 0.292 inch in the first 1.5 hours for an average rate of about 0.195 inch per hour or 0.0032 inch per minute; 0.300 inch in the first 2.0 hours for an average rate of about 0.150 inch per hour or 0.0025 inch per minute; 0.350 inch in the first 2.5 hours for an average rate of about 0.140 inch per hour or 0.0023 inch per minute; and 0.380 inch in the first 3.0 hours for an average rate of about 0.127 inch per hour or 0.0021 inch per minute. Thus, this embodiment of resin 14 would reach the total penetration of cyanoacrylate in only about two minutes or less and the total penetration of the two-part epoxies and polyesters noted in the Background section in only about six to nine minutes or less. In addition, the excess resin 14 is reusable, unlike the prior art coatings or resins noted herein.

The test showed also shows that the penetration depth of resin 14 into such a prototype easily reaches 0.20 to 0.25 inch in only 30 minutes and that the 0.253 to 0.380 inch penetration depth range is substantially greater than that achieved by the known prior art at atmospheric pressure. Use of the elevated temperature of the test with these prior art coatings or resins would render them ineffectual.

Resin 14 is preferably a non-volatile, non-styrenated unsaturated polyester thermoset resin having properties particularly suited to the present method. For instance, resin 14 may be heated up to 80° C. with substantial stability, an unusual characteristic in itself. In addition, resin 14 needs be heated only to approximately 100° C. to initiate the curing process, a rather low temperature especially in light of the temperature to which resin 14 may be heated while maintaining stability and being suitable for infusion into a porous form such as form 12. In addition, its non-volatile nature allows it to be effectively placed under vacuum even at the elevated temperatures without volatilization for the purposes of the present method of infusion. By way of example, tests have shown that resin 14 experiences no weight loss at temperatures up to 70° C. (158° F.) and under vacuum at 28 to 29 inches of water. In addition, it has highly desirable characteristics when cured to form a solid material. Various characteristics of resin 14 are provided further below.

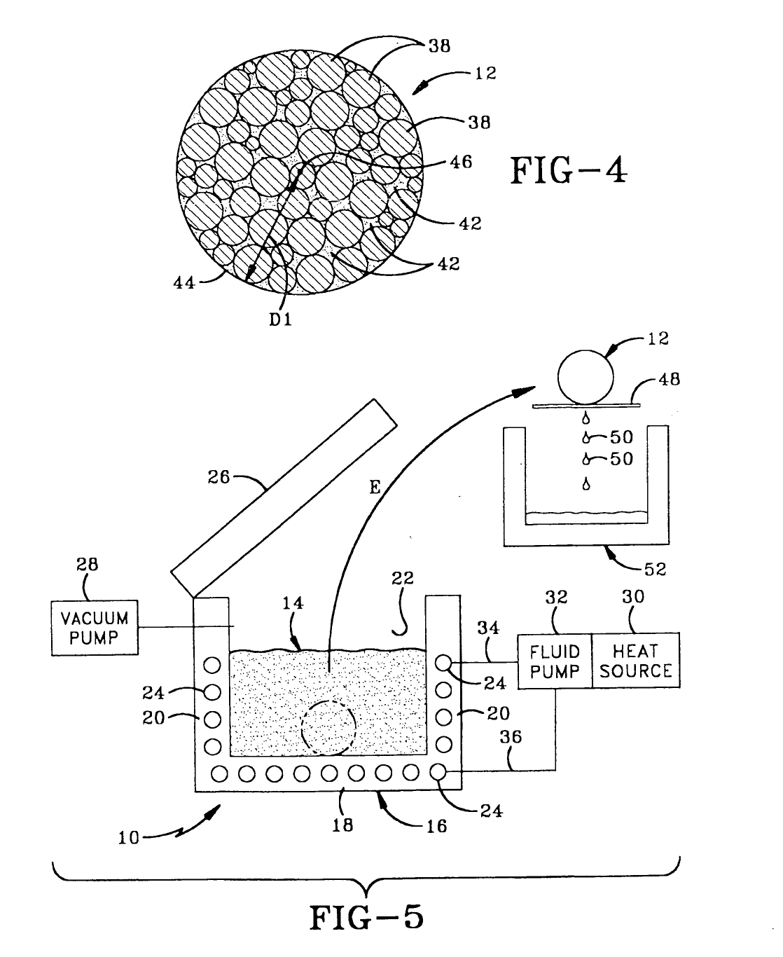

The present vacuum-related method of infusion easily provides full or nearly full penetration of the interstitial spaces of form 12. This is represented in FIG. 4 by showing those spaces that were formerly gas-filled (FIG. 2) as liquid-resin-filled interstitial spaces 42. This penetration or penetration depth is represented as a depth or distance D1 in FIG. 4, which extends between an outer surface 44 of form 12 to a center 46 thereof. Depth D1 also more generally represents any depth or distance of penetration desired, which is dependent upon the viscosity of liquid resin 14, the degree of vacuum within resin chamber 16 and the amount of time that form 12 is submerged while under vacuum.

Testing of infusion of one embodiment of resin 14 into a powder bed prototype produced on a Z Corp 3D printer provided the following results for infusion or penetration rates using the above method. The prototypes tested were rectangular blocks or parallelepipeds measuring two inches by two inches by five inches. Resin 14 was maintained at a temperature of 60° C. at a vacuum level of about 28 to 29 inches of water. After 30 minutes, penetration into the part was 0.468 inch measured from the bottom of the part; 0.511 inch measured from the top of the part; 0.438 inch measured from one side of the part; and 0.416 inch measured from the opposite side of the part; whereby the average penetration was 0.458 inch for an average penetration rate of 0.916 inch per hour or 0.015 inch per minute during the first 30 minutes. Under the same conditions, after 45 minutes, penetration into the part was 0.578 inch measured from the bottom of the part; 0.607 inch measured from the top of the part; 0.622 inch measured from one side of the part; and 0.635 inch measured from the opposite side of the part; whereby the average penetration was 0.6105 inch for an average penetration rate of 0.814 inch per hour or 0.013 inch per minute during the first 45 minutes. Thus, a porous form such as that formed on a powder bed 3D printer and having a square cross section 1 inch by 1 inch can be fully infused within 30 to 45 minutes under the present method.

It is noted that while resin 14 may be infused into form 12 at atmospheric pressure as described earlier, infusion under vacuum is preferred, not only to expedite penetration, but also in order to provide better assurance that the penetration is full and also that the distribution of resin 14 is substantially even within form 12. In some cases where infusion was performed at atmospheric pressure, even apparently “full” penetration led to parts which when cured had varying degrees of warpage. This is best explained by a somewhat uneven distribution of resin within the form. Infusion under vacuum substantially minimizes or eliminates this problem.

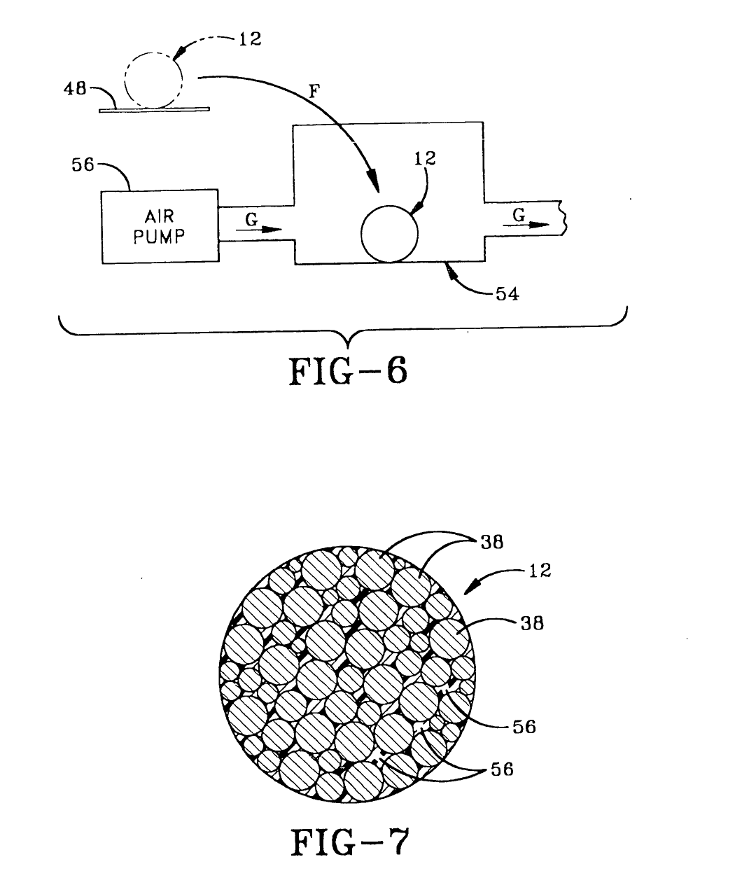

Referring to FIG. 5, once porous form 12 has been impregnated to a desired degree of penetration, the vacuum is taken off to return cavity 22 to an ambient pressure so that chamber 16 may be opened and form 12 may be removed as indicated at Arrow E and placed on a draining rack 48. Liquid resin 14 is then allowed to drain from form 12 as represented by drops 50 into a container 52 in which resin 14 may be stored for subsequent use in the infusion process. Once form 12 is sufficiently drained, it is moved as indicated at Arrow F in FIG. 6 into a curing apparatus preferably in the form of a forced air oven 54 which is heated as an air pump 54 pumps air through its interior chamber as indicated at Arrows G in FIG. 6. While the resin impregnated form 12 may be heated for curing in any number of ways known in the art, the forced air oven 54 is useful in order to provide uniform heating of form 12.

While the curing temperature may vary somewhat, the resin-impregnated form is typically cured at a temperature ranging from 100-200° C. (212-392° F.). Oven curing times vary with the mass and thickness of form 12. However, for most parts likely to be produced by the present method, the following example is representative of an effective curing process. More particularly, impregnated form 12 is heated to 100-110° C. (212-230° F.) for about one hour. At this time, any additional resin that is drained from form 12 may be removed. Form 12 is subsequently heated to 120-135° C. (248-275° F.) for 1-3 hours and then at about 150° C. (302° F.) for an additional hour.

Higher temperatures may be applied to improve the cured properties of the resin and final product, including higher tensile and compressive strength, higher surface hardness, additional temperature resistance and additional chemical or solvent resistance. Stiffness of the product also typically increases with higher curing temperatures. In most cases, the Tg (glass transition temperature) and solvent resistance will continue to increase with the increase in curing temperature up to about 200° C. (392° F.). Typically, all other physical properties of the cured resin are achieved by heating form 12 to approximately 160° C. (320° F.) although this may vary.

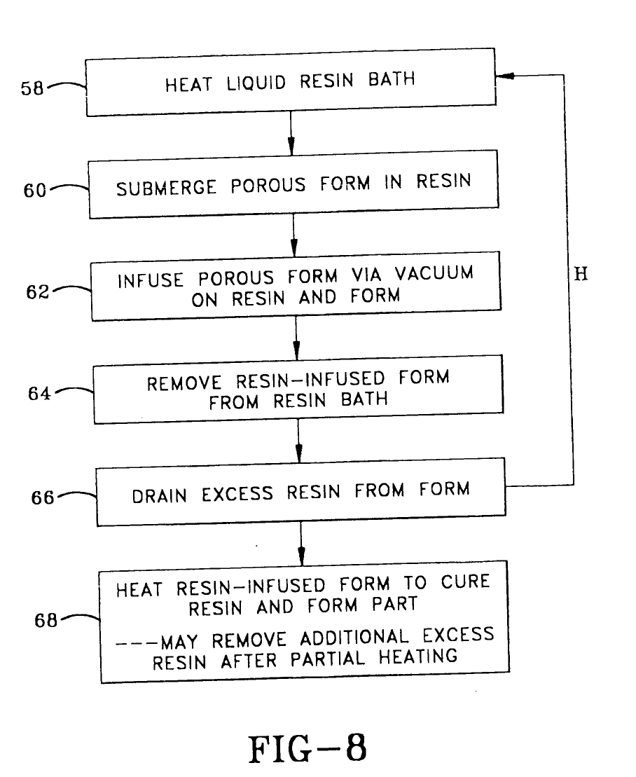

Once the impregnated form 12 is cured, the interstitial spaces which were formerly filled by liquid resin 14 have become solid resin, as represented by solid resin-filled spaces 56 in FIG. 7. More particularly, “spaces” 56 are now solidified resin 14 particles 56 which forms a matrix of interlinked solid resin particles intertwined with a matrix of interlinked particles 38 to form a combined matrix of particles 38 and 56 which are interlinked with one another. Due to some shrinkage during the curing process, the average size of the spaces 56 in which solid resin 14 is disposed between particles 38 is slightly smaller than pores 40 of the pre-infused porous form 12. However, the range of sizes given above for particles 38 and pores 40 nonetheless applies to the particles 38 and spaces or particles 56 of the cured part.

At this point, form 12 has become a final product which has physical properties far different than the porous form with which the process began. The final product is very hard and much tougher than known prior art resin impregnated forms. For example, the final product has been produced as the head of a hammer which is capable of driving sizable nails into hard woods. The final product is generally very difficult to break. Compressive strengths in excess of 30,000 pounds per square inch (psi) have been produced. As a result, the product produced by the present method is usable for a very wide range of purposes. See Tables 1 and 2 further below for additional information on various physical properties of the cured parts.

With reference to FIG. 8, the basic method of infusion and curing is shown in flow chart form. The liquid resin is first heated as indicated at 58 in order to reduce the viscosity of the resin to a desired level to expedite infusion. The porous form is submerged in liquid resin as indicated at 60 and subsequently infused with a resin by placing a vacuum on the resin and the form within a resin chamber as indicated at 62. Once the porous form has been infused or impregnated with the resin to the degree desired, which may be substantially 100%, the resin infused form is removed from the resin bath as indicated at 64 and excess resin is allowed to drain therefrom as indicated at 66. Although the resin has been heated during the process, the resin of the present invention allows for the reuse of this excess resin for the purpose of infusion, as indicated at Arrow H. Once the excess resin has been drained from the resin-infused form, the form is heated to cure the resin and form the final part as indicated at 68. As also indicated at 68, excess resin may be removed from the resin-infused form after partial heating of the form. Thus, the final part requires little if any finishing steps subsequent to the curing process.

With reference to FIGS. 9-12, the second method of resin infusion is described. As shown in FIG. 9, porous form 12 is placed in chamber 16 and held above the heated bath of liquid resin 14 by a suitable support mechanism (not shown) within chamber 16 while pump 28 applies a vacuum to remove air from form 12 and resin 14 (Arrows J). Most preferably, all or substantially all of the air is removed from within chamber 16, and thus from form 12 and resin 14. FIG. 10 shows that form 12 is then lowered (Arrow K) into resin 14 while still under vacuum. Referring to FIG. 11, pump 28 then ceases to pull a vacuum on chamber 16 and the vacuum is broken, such as by opening a valve (not shown) to allow external air back into cavity 22 (Arrow L), so that form 12 and resin 14 are brought back to atmospheric pressure whereby resin 14 flows into form 12 (Arrows M). Form 12 is typically fully infused with resin 14. The second method provides a quicker infusion rate of resin 14 into form 12 once the vacuum is broken, and also allows infusion with a higher viscosity of resin 14. Thus, for a given resin, the temperature may be lower while still achieving the infusion, or resins which have generally higher viscosities may be used with success. Once infusion has occurred, the second method is the same as the first method beginning at FIG. 5. In short, form 12 is removed from the resin bath to drain excess resin and then placed in the curing oven to thermally cure as previously described.

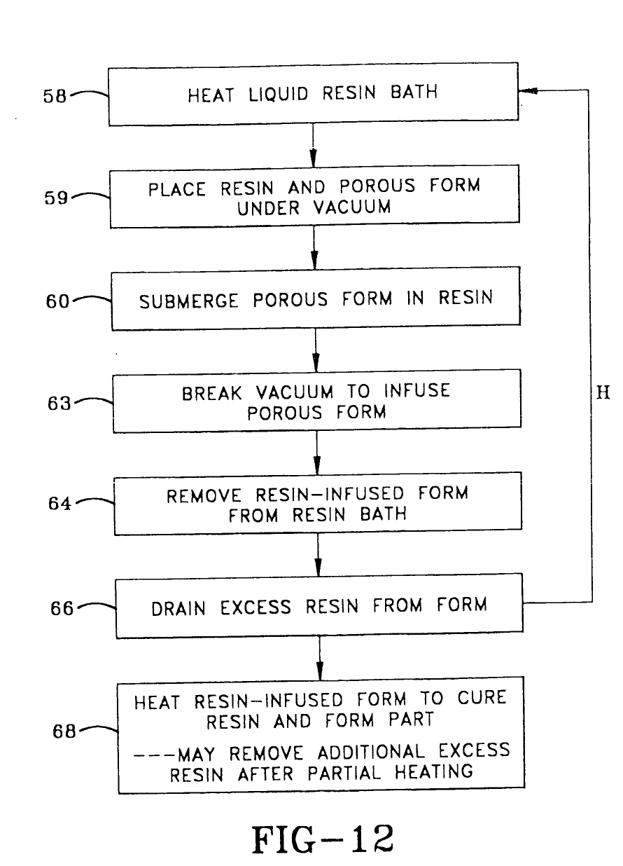

The basic steps of the second method are shown in flow chart form in FIG. 12 and are similar in many ways to those of the first method shown in FIG. 8. However, as previously noted, the second method varies in that, after liquid resin is heated as indicated at 58, form 12 and resin 14 are placed under vacuum, as at 59, before form 12 is submerged in resin 14 while maintaining the vacuum, as at 60. Then the vacuum is broken to expedite infusion, as at 63, facilitated by the pressure differential between the atmospheric pressure on resin 14 and the vacuum in the interstitial spaces within form 12. This method of infusion is even faster than that of the first method and helps provide a more uniform gradient of resin 14 within form 12. The process is then the same as the first method. Resin infused form 12 is removed from the resin bath, as at 64, excess resin is drained therefrom, as at 66, which is reusable (Arrow H) and the form is heated to cure the resin and form the final part, as at 68. Excess resin may be removed after partial heating of the form, also at 68.

TABLE 1
Hardness and Compressive Strength of Cured Resin-Infused Forms

| Pre-infusion | | Hardness | Compressive |
|---|---|---|---|
| Status of | | Shore D | Strength |
| Porous Form | | Low/High | Low/High |
| | Degree of Infusion | | |
| Not pre-baked | Not infused | 46/59 | 50/50 |
| | Fully infused | 73/78 | 3000/3950 |
| | Partially infused/“shell” | 61/79 | 2400/2900 |
| Pre-baked | Not infused | 60/63 | 1650/1900 |
| 12 hrs at 120° C. | Fully infused | 93/94 | 20000/23000 |
| | Partially infused/“shell” | 90/94 | 2200/3200 |
| Pre-baked | Not infused | 58/59 | 250/2000 |
| 3 hrs at 120° C. | Fully infused | 89/90 | 19000/22000 |
| | Partially infused/“shell” | 84/86 | 3000/3250 |
| Pre-baked | Not infused | 66/72 | 450/650 |
| 1 hr at 120° C. | Fully infused | 90/93 | 19000/22000 |
| | Partially infused/“shell” | 78/81 | 2950/4250 |
| Pre-baked | Not infused | 46/62 | 425/450 |
| 12 hrs at 140° C. | Fully infused | 92/96 | 25000/30000 |
| | Partially infused/“shell” | 80/86 | 2400/3000 |
| Pre-baked | Not infused | 60/61 | 250/1900 |
| 3 hrs at 140° C. | Fully infused | 91/94 | 20000/23000 |
| | Partially infused/“shell” | 72/80 | 2100/2150 |
| | (Prior Art Resins) | | |
| Not pre-baked | Epoxy (0.015 inch) | 48/62 | 800/850 |
| Not pre-baked | Cyanoacrylate | 42/78 | 800/1000 |
| | (0.050–0.070 inch) | | |

Table 1 Notes:
1 - All porous forms produced via Z Corp 3D powder bed printer
2 - All parts were cylinders with 1-inch height and ½ sq. in. circular surface area
3 - Partially infused/“shell” parts infused for 30 min. at 60° C. and atmospheric pressure
4 - All parts formed with resin of the present invention cured for 3 hours at 120° C.

TABLE 2
Additional Physical Properties of Cured Resin-Infused Forms

| | | | Notched | | |
|---|---|---|---|---|---|
| | | Flexural | Izod | Arc Trac | Barcol |
| Infusion | Degree | Strength | Impact | Resistance | Hard- |
| Material | of Infusion | (psi) | (ft/lb) | (seconds) | ness |
| Cyano- | (0.050–0.070 in) | 2027 | 0.48 | 130 | 15 |
| acrylate | | | | | |
| Epoxy | (0.015 in) | 3150 | 0.52 | 125 | 26 |
| Applicants' | Fully infused | 4093 | 0.58 | 170 | 48 |
| Resin | Partially infused | 2926 | 0.49 | 133 | 35 |

Table 2 Notes:
1 - All porous forms produced via Z Corp 3D powder bed printer and infused with the listed Infusion Material
2 - Flexural Strength test in accordance with ASTM D790-91
3 - Notched Izod Impact test in accordance with ASTM D256-90
4 - Partially infused parts infused for 30 min. at 60° C. and atmospheric pressure
5 - All parts formed with resin of the present invention cured for 3 hours at 120° C.
6 - Barcol Hardness test readings for cyanoacrylate varied from 0 to 15, indicating that some surface areas were below the test threshold

The present invention thus provides cured resin-infused parts with physical characteristics highly suited for handling and testing, and methods of producing such parts by infusing fine-pored porous forms with a reinforcing resin which is fully catalyzed but has excellent stability even when heated to 70° C. (158° F.) or above. In short, the present apparatus and methods of infusion and curing provide structure and processes which are simple and cost effective and which produces an end product with the substantially improved physical characteristics described herein.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method comprising the steps of:
heating liquid resin to a temperature of at least 35° C. to lower its viscosity;
infusing a porous form with the heated resin; and
curing the infused resin.

2. The method of claim 1 wherein the step of heating comprises the step of heating the liquid resin to lower its viscosity to no greater than 1,000 cPs.

3. The method of claim 2 wherein the step of heating comprises the step of heating the liquid resin to lower its viscosity to no greater than 500 cPs.

4. The method of claim 1 wherein the step of heating comprises the step of heating the liquid resin to a temperature ranging from 40° C. to 70° C.

5. The method of claim 1 wherein the step of heating comprises the step of heating a non-styrenated unsaturated polyester thermoset resin to a temperature of at least 35° C.

6. The method of claim 1 wherein the step of heating comprises the step of maintaining the resin in liquid form at a temperature of at least 35° C. continuously for a period of at least 30 minutes; and the step of infusing occurs after the step of maintaining.

7. The method of claim 1 wherein the step of infusing comprises the step of infusing the porous form with the heated resin to a penetration depth of at least 0.20 inch.

8. The method of claim 7 wherein the step of infusing comprises the step of infusing the porous form with the heated resin to a penetration depth of at least 0.40 inch.

9. The method of claim 1 wherein the step of curing comprises the step of heating the resin-infused form to a temperature of at least 90° C.

10. The method of claim 9 wherein the step of curing comprises the step of heating the resin-infused form to a temperature of at least 100° C.

11. The method of claim 1 wherein the step of curing comprises the step of curing the infused resin to produce a resin-infused form having a compressive strength of at least 2,000 psi.

12. The method of claim 11 wherein the step of curing comprises the step of curing the infused resin to produce a resin-infused form having a compressive strength of at least 5,000 psi.

13. The method of claim 12 wherein the step of curing comprises the step of curing the infused resin to produce a resin-infused form having a compressive strength of at least 10,000 psi.

14. The method of claim 1 wherein the step of curing comprises the step of curing the infused resin to produce a resin-infused form having a Shore D hardness of at least 60.

15. The method of claim 1 further comprising the step of heating the porous form to a temperature of at least 100° C. before the steps of infusing and curing.

16. The method of claim 1 further comprising the step of submerging the porous form in the liquid resin.

17. The method of claim 16 further comprising the step of placing the porous form and liquid resin under vacuum.

18. The method of claim 17 wherein the step of placing occurs before the step of submerging.

19. The method of claim 18 further comprising the step of breaking the vacuum to facilitate the flow of resin into the submerged form.

20. The method of claim 17 wherein the step of infusing comprises the step of infusing substantially all of the porous form with the resin; further comprising the step of draining excess resin from the resin-infused form; and wherein the step of curing comprises the step of heating the drained resin-infused form to a temperature of at least 100° C.
